(19) United States
(12) Patent Application Publication
(10) Pub. No.: US 2012/0276758 A1
(43) Pub. Date: Nov. 1, 2012

(54) METHOD FOR CONTACTING A PRINTED CIRCUIT BOARD HAVING ELECTRIC CONTACTS ON BOTH SIDES AND SUCH A PRINTED CIRCUIT BOARD

(75) Inventors: Thomas Donauer, Kelheim (DE); David Dussault, Neutraubling (DE); Harald Stoyan, Rettenbach (DE)

(73) Assignee: OSRAM AG, Munich (DE)

(21) Appl. No.: 13/512,573

(22) PCT Filed: Nov. 12, 2010
(86) PCT No.: PCT/EP2010/067356

§ 371 Date: Jun. 19, 2012

(30) Foreign Application Priority Data
Nov. 26, 2009 (DE) 10 2009 055 859.4

(51) Int. Cl. H01R 12/72

(52) U.S. Cl. 439/59

(57) ABSTRACT

A method for contacting a printed circuit board (1; 14, 15) provided with electrical contacts (8a-8d) on both sides (2, 5), wherein the electrical contacts (8a-8d) on both sides (2, 5) of the printed circuit board (1; 14) are at least partially contacted by at least one ZIF connector (10a, 10b; 13).

The invention relates to a method for contacting a printed circuit board provided with electrical contacts on both sides. The invention also relates to a printed circuit board provided with electrical contacts on both sides.

LED light strips having a flexible and populated printed circuit board printed on one side are known which on said side also have electrical contacts at the long-side ends of the printed circuit board. On the other, non-printed side the printed circuit board is fitted with a double-sided adhesive tape for attaching the LED light strip. Such LED light strips are known e.g. from the LINEARLight LMXX series of the company Osram. The LED light strips can be electrically contacted, e.g. connected to a current source or a further LED light strip, by inserting a single-sided contact connector onto the electrical contacts. Such a connector can be a single-sided contact ZIF (Zero Insertion Force) connector from the LM series of connecting elements of the company Osram, which connector is compatible with the LED light strips of the LINEARLight LMXX series.

Printed circuit boards that are printed on both sides are generally known and can be more complex in terms of design and wiring layout than printed circuit boards that are printed on one side.

It is the object of the present invention to provide a possible way of contacting even printed circuit boards of more complex design, in particular flexible printed circuit boards, in a simple and fault-resistant manner.

This object is achieved according to the features of the independent claims. Preferred embodiment variants can be derived in particular from the dependent claims.

The object is achieved by means of a method for contacting a printed circuit board that is provided with electrical contacts on both sides (i.e. the front side or top side and the back side or underside), wherein the electrical contacts on both sides of the printed circuit board are at least partially contacted by means of at least one ZIF connector.

In other words, the printed circuit board provided with electrical contacts on both sides is contacted in such a way that at least some of the contacts on one side (e.g. the front side) are contacted by means of at least one ZIF connector and at least some of the contacts on the other side (e.g. the back side) are contacted by means of at least one (the same or a different) ZIF connector.

The advantage resulting from said method is that a double-sided printed circuit board can have a more complex wiring layout and at the same time be contacted easily, since both sides can be used for contacting. In this way it is possible for example to dispense with a plated-through hole solely for the purpose of the printed circuit board being contacted from one side only.

The printed circuit board can be populated with components, in particular fitted with at least one light source, in particular at least one light-emitting diode, on one side or on both sides. The printed circuit board can then be embodied as a lighting device, in particular a LED lighting device.

It is one embodiment that the electrical contacts present on one of the sides of the printed circuit board are at least partially contacted by means of at least one single-sided contact ZIF connector and the electrical contacts present on the other of the sides of the printed circuit board are contacted by means of at least one further single-sided contact

ZIF connector. Particularly cost-effective and fault-resistant plug-in contacting can also be achieved through the use of the single-sided contact ZIF connectors.

It is an alternative embodiment that at least some of the electrical contacts present on each of the sides of the printed circuit board are contacted by means of at least one double-sided contact ZIF connector. This enables the number of ZIF connectors required as a minimum for double-sided contacting to be reduced.

Generally the electrical contacts of one side can be contacted by means of one or more ZIF connectors. The electrical contacts of a printed circuit board can be divided into homogeneous groups of contacts for contacting or into heterogeneously embodied groups of contacts. Accordingly, at least two groups of electrical contacts, each of which is provided for contacting by means of a ZIF connector, can be embodied as physically identical and can therefore be contacted by means of the same ZIF connector and/or at least two groups of electrical contacts can be embodied as physically different. The printed circuit board can also be contacted by means of a combination of at least one single-sided contact ZIF connector and at least one double-sided contact ZIF connector.

It is also an embodiment that the at least one ZIF connector is inserted onto at least one long-side end of a strip-shaped printed circuit board. This enables the number of contacts, which is limited by the width of the printed circuit board, to be increased by means of low-cost and fault-resistant ZIF connectors. A wiring layout can also be simplified.

It is a special embodiment that the at least one long-side end is provided with electrical contacts on both sides. This enables double-sided ZIF connectors to be beneficially used and/or a connection variation to be increased in size.

In particular at least two single-sided contact ZIF connectors rotated through 180° relative to each other can be inserted onto the strip-shaped printed circuit board at opposite long-side ends. Alternatively, at least one double-sided contact ZIF connector can be inserted onto at least one long-side end. A combination of a single-sided ZIF connector and double-sided ZIF connector is also possible, e.g. with the double-sided ZIF connector as an extension cable.

It is furthermore an embodiment that the long-side end has been produced previously by splitting the strip-shaped printed circuit board at a division line crossing a plurality of contact conductor tracks, in particular crossing said conductor tracks at right angles. This means that a light strip or a printed circuit board with a customized length can be provided.

It is additionally an embodiment that the division line crosses the contact conductor tracks asymmetrically, in particular at right angles to a longitudinal division, so that one side of the divided contact conductor tracks is longer than the other. This enables a sufficient length of the electrical contacts of the printed circuit board to be realized even with a small pitch of light sources, in particular light-emitting diodes, on the printed circuit board.

It is yet another embodiment that the printed circuit board is a flexible printed circuit board.

The object is also achieved by means of a printed circuit board, wherein the printed circuit board is provided with electrical contacts on both sides and the electrical contacts on both sides of the printed circuit board are at least partially contacted by means of at least one ZIF connector.

It is a development that the printed circuit board or a light strip composed of a plurality of printed circuit boards mechanically and electrically connected in series (then also referred to as sections) has at least one marking to indicate at least one asymmetric division line.

The invention is described in more detail below with reference to exemplary embodiments taken in conjunction with the schematic figures, in which for clarity of illustration reasons like or like-acting elements are labeled with the same reference signs.

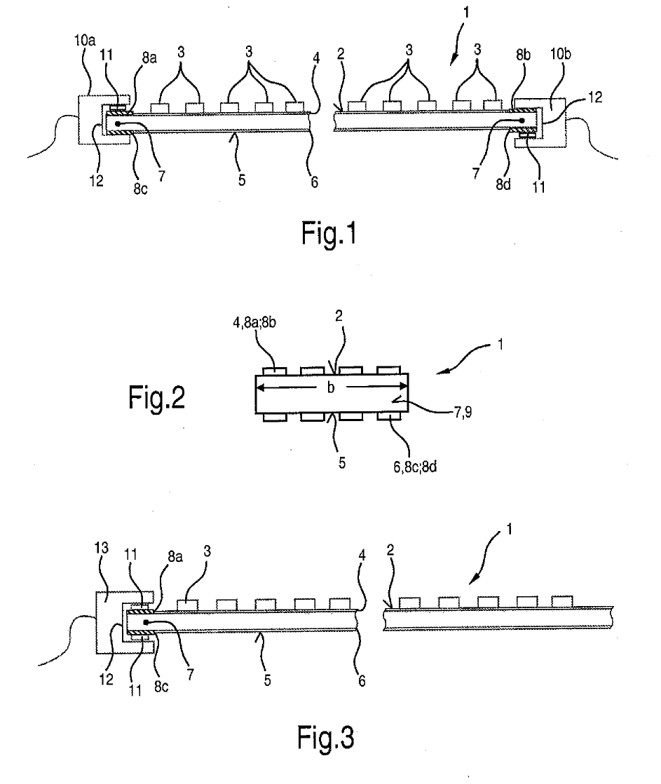

FIG. 1 shows a side view of a printed circuit board in a first connection configuration in a sectional representation;

FIG. 2 shows a long-side end of the printed circuit board in a view along a longitudinal extent of the printed circuit board;

FIG. 3 shows a side view of the printed circuit board in a second connection configuration in a sectional representation;

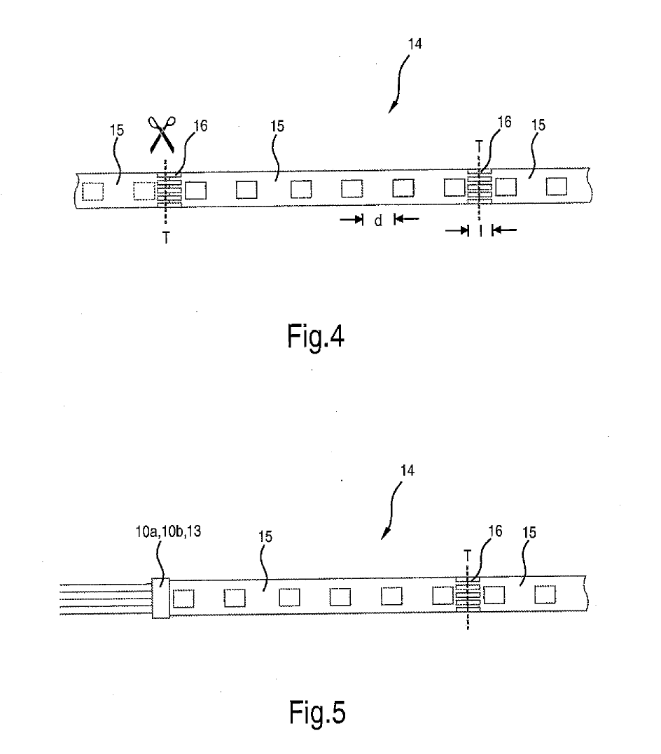

FIG. 4 shows a detail of a divisible light strip in a plan view; and

FIG. 5 shows the partially divided and connected light strip in a plan view.

FIG. 1 shows a side view of a populated flexible printed circuit board 1 embodied as a light strip in a sectional representation. A front side 2 of the printed circuit board 1 is loaded with light-emitting diodes 3 as well as further electronic components as necessary, such as integrated components, resistors, capacitors, etc. In order to wire the light-emitting diodes 3 and the further electronic components the printed circuit board 1 is provided, in particular printed, on its front side 2 with a wiring layout 4 (conductor tracks, contact surfaces, etc.). So that more complex wiring patterns can also be realized, the printed circuit board 1 is also provided, e.g. printed, on its back side 5 with a wiring layout 6 (in particular conductor tracks), though no components are mounted thereon. The wiring layout 6 of the back side 5 is electrically connected to the light-emitting diodes 3, to the components and/or to the wiring layout 4 of the front side 2 through the printed circuit board 1, for example by means of corresponding plated-through holes (not shown).

For contacting the printed circuit board 1 for power supply purposes and possibly also for data communication, the wiring layouts 4, 6 are embodied at the two long-side ends 7 of the printed circuit board 1 as electrical contacts 8a-8d, and specifically in relation to the front-side wiring layout 4 on the front side 2 as a first group of electrical contacts 8a at one of the long-side ends 7 and as a second group of electrical contacts 8b at the other of the long-side ends 7, as well as in relation to the back-side wiring layout 6 as a third group of electrical contacts 8c at one of the long-side ends 7 and as a fourth group of electrical contacts 8d at the other of the long-side ends 7. The contacts 8a and 8c are identical in design to the contacts 8b and 8d and connected in the same way, i.e. the two long-side ends 7 have in particular identical connection characteristics. It is therefore immaterial for operation of the printed circuit board 1 or of the light strip whether the contacts 8a or 8b or the contacts 8c or 8d are connected. FIG. 2 shows the printed circuit board 1 with the electrical contacts 8a and 8c or 8b and 8d in a view along a longitudinal extent of the printed circuit board 1 onto a long-side end 7 or an end-side or face-side lateral surface 9. In this case the electrical contacts 8a-8d are arranged spaced apart at the same distance from one another.

Again with reference to FIG. 1, a first single-sided contact ZIF (Zero Insertion Force) connector 10a is plugged onto the long-side end 7 (shown on the left here) of the printed circuit board 1, at which end the first group of contacts 8a and the third group of contacts 8c are located, for the purpose of contacting the printed circuit board 1. The first ZIF connector 10a has its electrical contacts 11 on one side of its connector recess 12 only, and moreover is embodied in one plane for contacting one group of contacts 8a-8d only. In this case the first ZIF connector 10a contacts the first group of contacts 8a, while the third group of contacts 8c is not contacted.

Analogously, a second single-sided contact ZIF (Zero Insertion Force) connector 10b is plugged onto the other long-side end 7 (shown on the right here) of the printed circuit board 1, at which end the second group of contacts 8b and the fourth group of contacts 8d are located. The second ZIF connector 10b is identical in design to the first ZIF connector 10a. The second ZIF connector 10b contacts the fourth group of contacts 8d, while the second group of contacts Bb is not contacted. The first ZIF connector 10a and the second connector 10b are therefore inserted rotated through 180° relative to each other or laterally transposed and contact the contact 8a and 8d, respectively, with different connection characteristics or a different assignment.

The advantage resulting from this arrangement is that a double-sided printed circuit board 1 with a limited width b (see FIG. 2) for arranging the electrical contacts 8a-8d can also be wired with a more complex wiring layout, since both long-side ends 7 can be used for contacting and correspondingly twice as many contacts can be used. In this case the contacts 8a, 8b and 8c, 8d are identical in terms of design and wiring layout, so that it is irrelevant for the operation of the printed circuit board 1 at which of the ends 7 the connectors 10a, 10b are inserted. As a result of the groups of electrical contacts 8a, 8b and 8c, 8d mounted on different sides 2, 5 it is furthermore possible to dispense with a plated-through hole solely so that both groups of contacts 8a, 8b and 8c, 8d are present on one side 3, 5; this also simplifies a layout of the wiring 4, 6 or of the printed circuit board 1. The arrangement shown has the further advantage that the known single-sided contact ZIF connectors 10a, 10b can be used for the contacting.

Alternatively it is also possible to dispense with the second group of contacts 8b and the third group of contacts 8c or with the first group of contacts 8a and the fourth group of contacts 8d, which simplifies a layout. The contacts 8a-8d can also be embodied as twist-resistant and/or have a different assignment. The printed circuit board can also be populated on both sides.

FIG. 3 shows a side view of the printed circuit board 1 with a different example of a connection configuration for a ZIF connector 13 in a sectional representation. In contrast to the first exemplary embodiment, the ZIF connector 13 is now fitted with electrical contacts 11 on two sides, so that when mounted onto one of the ends 7 it can, as shown, contact both associated groups of contacts, in this case 8a and 8b. This enables a second ZIF connector to be dispensed with. The ZIF connector 13 can optionally be inserted onto both ends 7.

Alternatively it is also possible to dispense with the third group of contacts 8c and the fourth group of contacts 8d or with the first group of contacts 8a and the second group of contacts 8b, which simplifies a layout. The ZIF connector 13 can then be mounted only onto the end 7 provided with the contacts 8a and 8b or 8c and 8d. Two double-sided ZIF connectors 13 can also be inserted, e.g. with one ZIF connector 13 as part of an extension cable.

FIG. 4 shows in a plan view a detail onto a divisible light strip 14 having a plurality of mechanically and electrically contiguous sections 15 which can be separated from one another, e.g. by cutting, wherein a single section 15 can constitute in particular a printed circuit board 1.

The light strip 14 is usually split along a predetermined division line T which lies transversely and symmetrically with respect to a group of contact conductor tracks 16 aligned in the longitudinal direction of the light strip 14, as indicated by the right-hand division line T. In the undivided state of the sections 15 the function of the contact conductor tracks 16 is to establish an electrical connection between adjacent sections 15. In the divided state the then likewise divided contact conductor tracks 16 serve as the contacts 8a and 8c or 8b and Bd. A length 1 of the contact conductor tracks 16 is limited by the distance d (‘pitch’) between adjacent light-emitting diodes 3, wherein a different distance d of the light-emitting diodes 3 of the light strip 14 should be avoided in order to realize a uniform lighting over the various sections 15.

With a small distance d, in particular with a distance of less than 10 mm, in the case of a typical symmetric division of the contact conductor tracks 16, in which the latter are cut in half, the length of the then produced contacts 8a-8d may no longer be sufficient for contacting by means of a ZIF connector 10a, 10b or 13. For this reason it can be preferred in the case of a small distance d to divide the contact conductor tracks 16 asymmetrically, as indicated by the left-hand division line T. This asymmetric division can be performed in particular such that the section 15 requiring to be contacted subsequently has sufficiently long contacts 8a-8d for contacting by means of the ZIF connector 10a, 10b or 13, as shown in FIG. 5, while the contacts of the adjacent section 15 are correspondingly shorter and can no longer be reliably contacted by means of the ZIF connector 10a, 10b or 13. The section 15 requiring to be contacted is shown here as the middle section 15. In order to assist a division with a correct length, the asymmetric division line T on the left can be identified by means of a marking.

It is self-evident that the present invention is not limited to the exemplary embodiments shown.

### LIST OF REFERENCE SIGNS

1 Printed circuit board

2 Front side of the printed circuit board

3 Light-emitting diode

4 Front-side wiring layout

5 Back side of the printed circuit board

6 Back-side wiring layout

7 Long-side end

8a Electrical contacts of a first group of contacts

8b Electrical contacts of a second group of contacts

8c Electrical contacts of a third group of contacts

8d Electrical contacts of a fourth group of contacts

9 Face-side lateral surface of the printed circuit board

10a First single-sided contact ZIF connector

10b Second single-sided contact ZIF connector

11 Electrical contacts of a ZIF connector

12 Connector recess

13 Double-sided contact ZIF connector

14 Light strip

15 Section of the light strip

16 Contact conductor track

b Width of the printed circuit board

d Distance between adjacent light-emitting diodes

l Length of the contact conductor track

T Division line

1. A method for contacting a printed circuit board provided with electrical contacts on both sides, wherein the electrical contacts on both sides of the printed circuit board are at least partially contacted by at least one ZIF connector.

2. The method as claimed in claim 1, wherein the electrical contacts present on one of the sides of the printed circuit board are at least partially contacted by at least one single-sided contact ZIF connector and the electrical contacts present on the other of the sides of the printed circuit board are contacted by at least one further single-sided contact ZIF connector.

3. The method as claimed in claim 1, wherein at least some of the electrical contacts present on each of the sides of the printed circuit board are contacted by at least one double-sided contact ZIF connector.

4. The method as claimed in claim 1, wherein the at least one ZIF connector is inserted onto at least one long-side end of a strip-shaped printed circuit board.

5. The method as claimed in claim 4, wherein the at least one long-side end is provided with electrical contacts on two sides.

6. The method as claimed in claim 4 wherein the long-side end has previously been produced by dividing the strip-shaped printed circuit board at a division line crossing a plurality of contact conductor tracks.

7. The method as claimed in claim 6, wherein the division line crosses the contact conductor tracks asymmetrically.

8. The method as claimed in claim 1, wherein the printed circuit board is a flexible printed circuit board.

9. A printed circuit board, wherein the printed circuit board is provided with electrical contacts on both sides and the electrical contacts on the two sides of the printed circuit board are at least partially contacted by at least one ZIF connector.

10. (canceled)
